(19) United States
(12) Patent Application Publication
(10) Pub. No.: US 2012/0037129 A1
(43) Pub. Date: Feb. 16, 2012

(54) OPPOSED PISTON ENGINE

(76) Inventors: Manousos Pattakos, Nikea Piraeus (GR); Paraskevi Pattakou, Nikea Piraeus (GR); Efthimios Pattakos, Nikea Piraeus (GR); Emmanouel Pattakos, Nikea Piraeus (GR)

(21) Appl. No.: 12/854,165

(22) Filed: Aug. 10, 2010

(51) Int. Cl. F02B 75/28

(52) U.S. Cl. 123/51 R

(57) ABSTRACT

A single-crankshaft single-cylinder fully-balanced opposed piston engine module that provides extra time for the injection and the combustion of the fuel.

This invention is for an opposed piston internal combustion engine.

Closest prior art: the OPRE, or Opposed piston Pulling Rod Engine PCT/IB2007/050809, the OPOC, or Opposed Piston Opposed Cylinder engine, U.S. Pat. No. 6,170,443, and the Junkers-Doxford engine, U.S. Pat. No. 1,679,976.

Close prior art is also the U.S. Pat. No. 4,732,115 of Lapeyre and the U.S. Pat. No. 4,115,037 of Milton.

In the OPRE engine the one of the opposed pistons is drivingly coupled, by a pullrod, to a first crankshaft, while the other of the opposed pistons is drivingly coupled, also by a pullrod, to a second crankshaft that rotates in synchronization to the first crankshaft.

This engine better fits to “divided load” applications, for instance as a range extender with two counter rotating electric generators each driven by one crankshaft of the OPRE, or as a Portable Flyer wherein each of the two counter-rotating crankshafts drives one propeller. In such “divided load” applications, the basis of the OPRE engine is not only rid of inertia vibrations of any kind, but it is also rid of power pulses vibrations of any kind, too. In comparison, the basis of the perfectly balanced Wankel Rotary engine cannot be rid of power pulses vibrations.

Besides its vibration-free operation, characteristics of the OPRE engine are also:

the extended combustion time as it provides some 30 to 40% longer piston dwell at the combustion dead center as compared to the conventional engine,

the improved volumetric efficiency of the built-in scavenging pumps because of the longer piston dwell at the maximum volume of the pump,

the improved lubrication quality, since the pistons do not need to thrust on the hot cylinder wall near and between the intake and exhaust ports, nor the piston rings need to touch the ports,

the compact, robust and lightweight structure.

The two connecting rods of the OPRE engine are “pulling rods” or “pullrods” in the sense that the high pressure into the combustion chamber loads these connecting rods exclusively in tension. On the same reasoning the connecting rods of a conventional engine are pushrods.

The OPOC basic module comprises two conventional, the inner ones, and two unconventional pistons. The conventional pistons thrust against the hot cylinder wall, onto the ports bridges, causing increased lubricant consumption. The unconventional pistons provide extended piston dwell at the combustion dead center, but the conventional pistons have the conventional piston dwell that makes the overall time available for the fuel injection and the combustion only slightly longer than in the conventional engine.

The U.S. Pat. No. 4,732,115 of Lapeyre necessitates pairs of cylinders and simultaneous combustion at pairs of combustion chambers.

The U.S. Pat. No. 4,115,037 of Milton involves a crankshaft located necessarily at one side of the cylinder.

An object of this invention is to improve the Junkers-Doxford engine, maintaining its simplicity and compactness, by keeping the center of gravity of the assembly of the two pistons substantially immovable. This is done by a different arrangement of the connecting rod of the lower piston.

A further object of this invention is to maintain the advantages of the OPRE engine eliminating the second crankshaft and the synchronizing gear. The pistons of the present invention perform the same motion with the pistons of the OPRE engine, i.e. they provide additional time for the injection of the fuel and the progression of the combustion. The distant to the combustion chamber side of the piston can serve as a scavenging pump.

A further object of this invention is to provide a full-balanced single-cylinder single-crankshaft two-piston module.

A further object of this invention is to provide a basic module for any configuration of multicylinder arrangements.

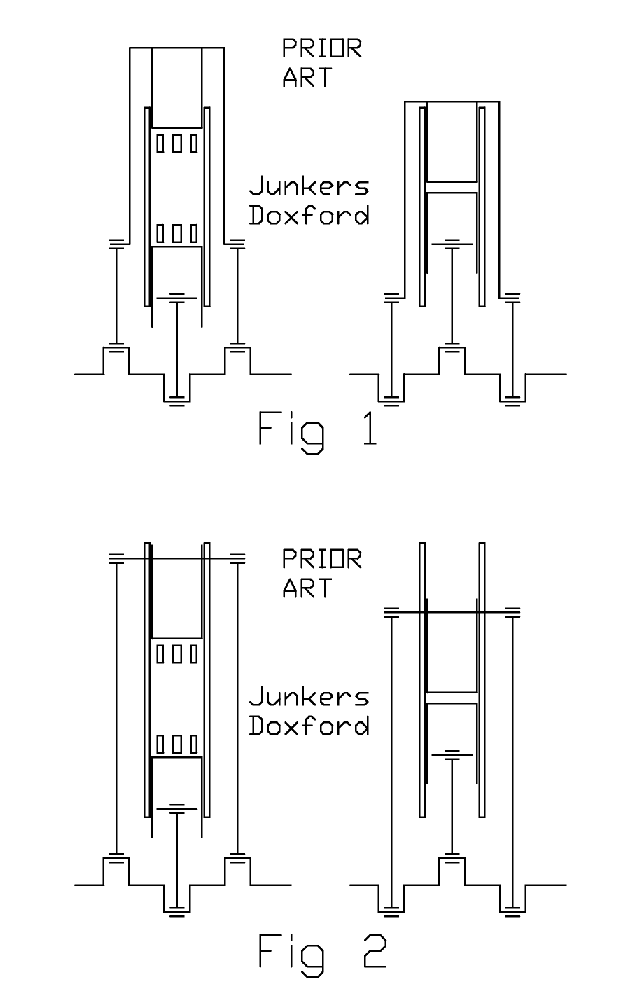

FIG. 1 shows the engine of Junkers-Doxford. The central connecting rod is a pushrod, the side connecting rods are pullrods.

FIG. 2 shows another version of the Junkers-Doxford engine wherein the side connecting rods extend to hold the piston pin. The thrust loads are taken by the piston skirt. The Junkers-Doxford engine suffers from 2nd order unbalanced inertia forces.

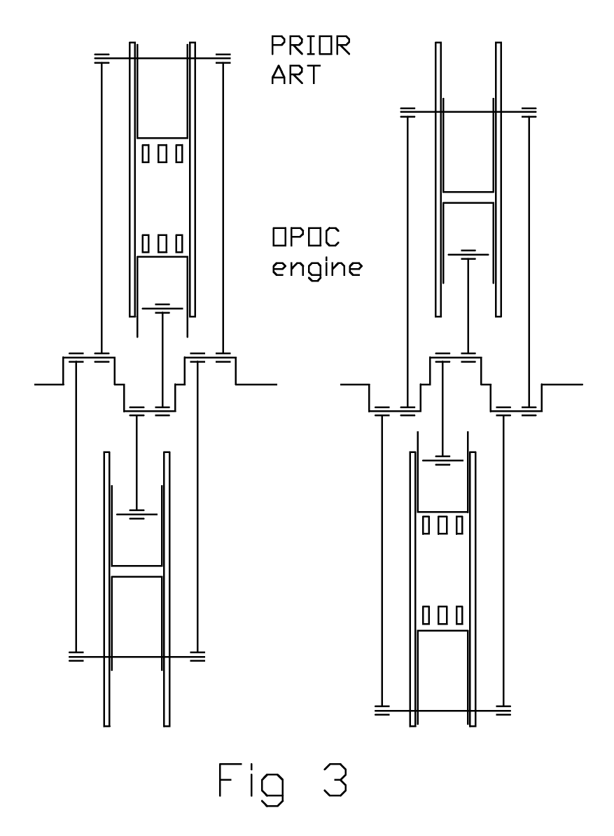

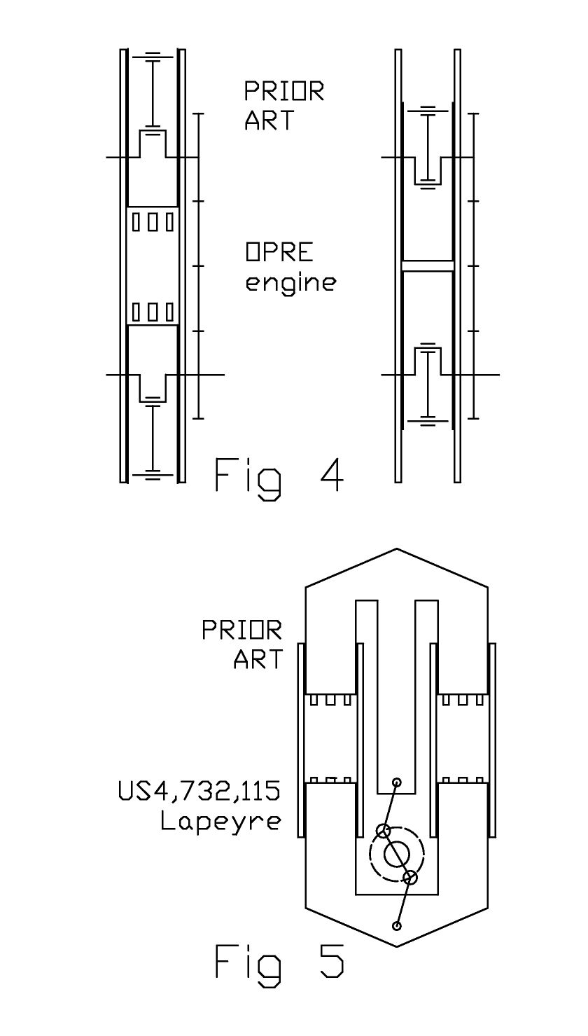

FIG. 3 shows the OPOC engine. The OPOC engine combines two Junkers-Doxford engines that share the same crankshaft for the sake of a better dynamic balance.

FIG. 4 shows the OPRE engine. It comprises two synchronized crankshafts.

FIG. 5 shows the engine of Lapeyre. It needs pairs of parallel cylinders. The crankshaft is outside the cylinders and its axis is away from the cylinder axes.

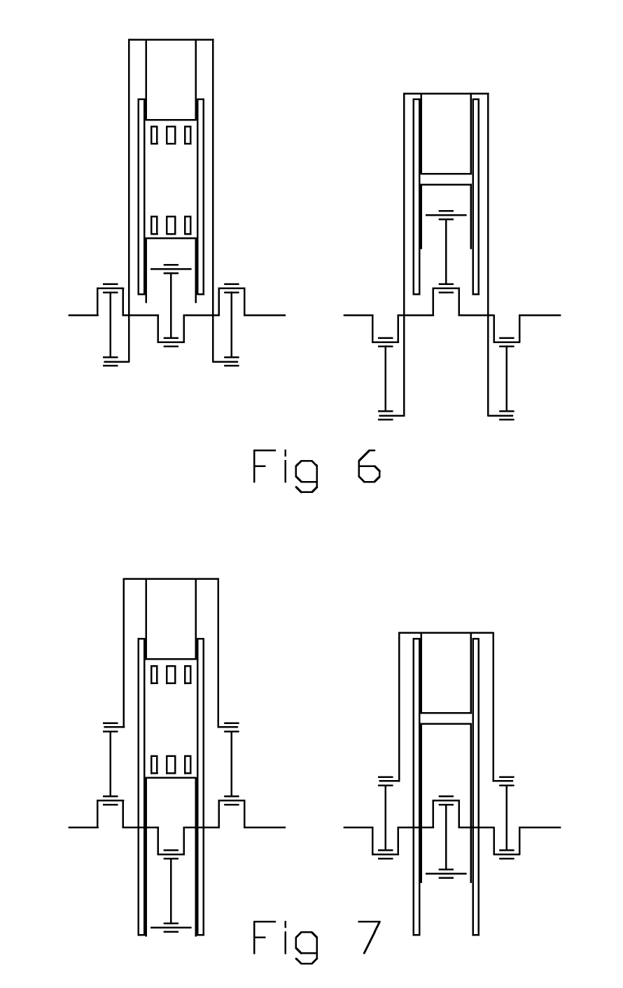

FIG. 6 shows an embodiment of this invention. The side connecting rods and the central connecting rod are all pushrods.

FIG. 7 shows another embodiment of this invention wherein the central and the side connecting rods are all pullrods.

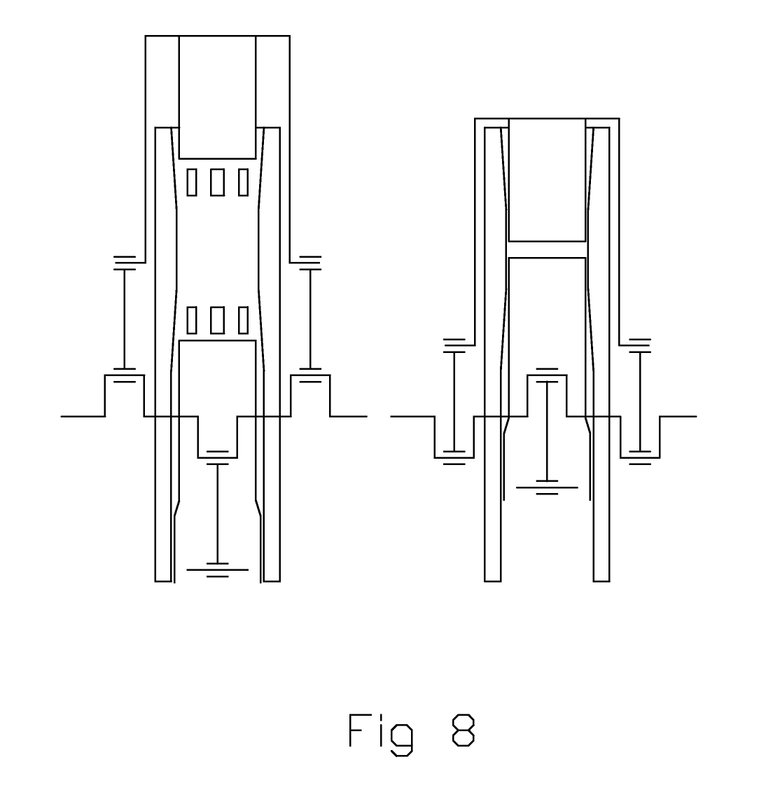

FIG. 8 shows the arrangement of FIG. 7 with a different cylinder: the cylinder bore increases, i.e. it is tapered, at the two ends of the cylinder. This way the piston rings can avoid touching the bore at a good part of the piston stroke, with the corresponding reduction of the friction and the wear. Also the piston skirt at the combustion side of the piston does not need to touch the hot cylinder because the thrust loads are taken at the “wrist pin” side of the piston, away from the combustion chamber.

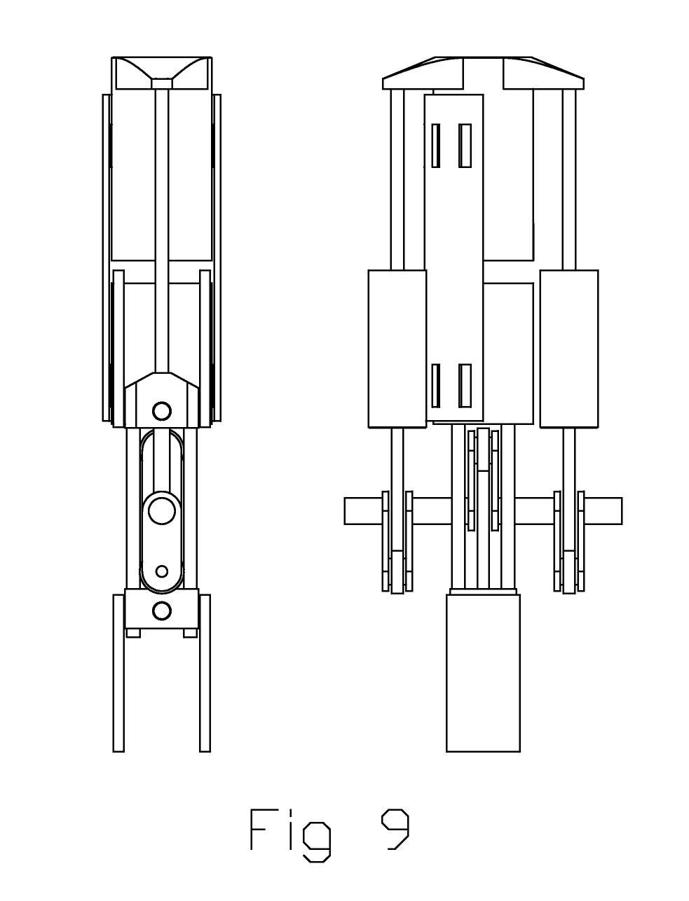

FIG. 9 shows an embodiment of this invention from two viewpoints. In this embodiment all connecting rods are pullrods. The engine is perfectly balanced as regards its inertia forces and moments. The cylinder is sliced to show more details. The pistons are at the combustion dead center, i.e. where the combustion chamber volume is minimized.

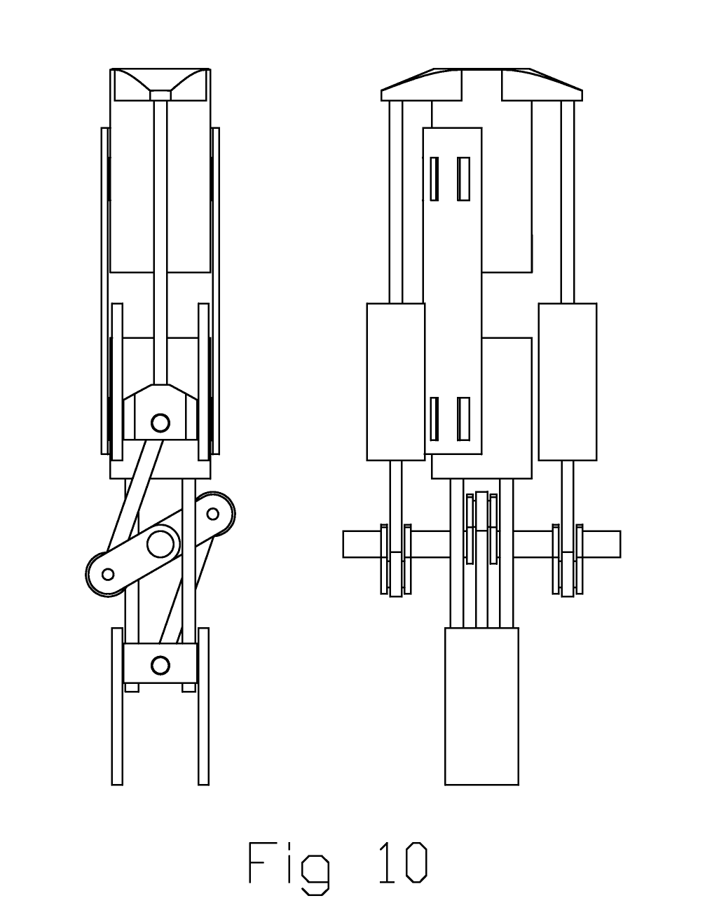

FIG. 10 shows the engine of FIG. 9 with the crankshaft rotated for 60 degrees.

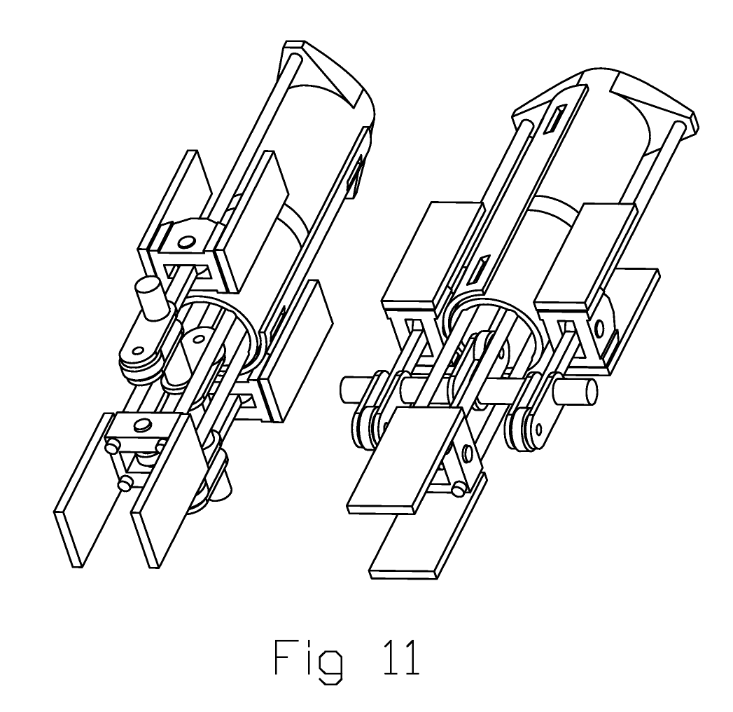

FIG. 11 shows the engine of FIG. 9 from another viewpoint.

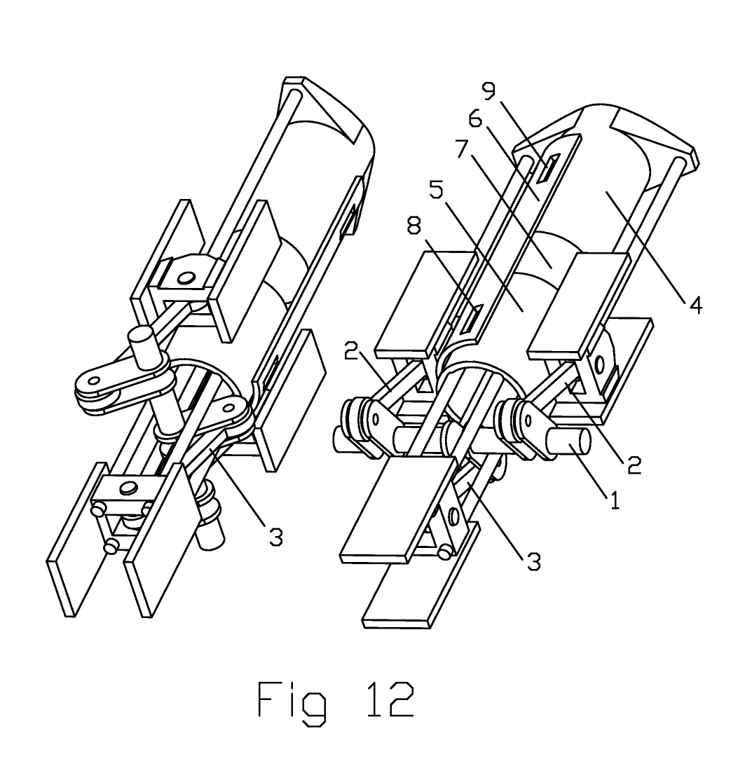

FIG. 12 shows the engine of FIG. 10 from another viewpoint.

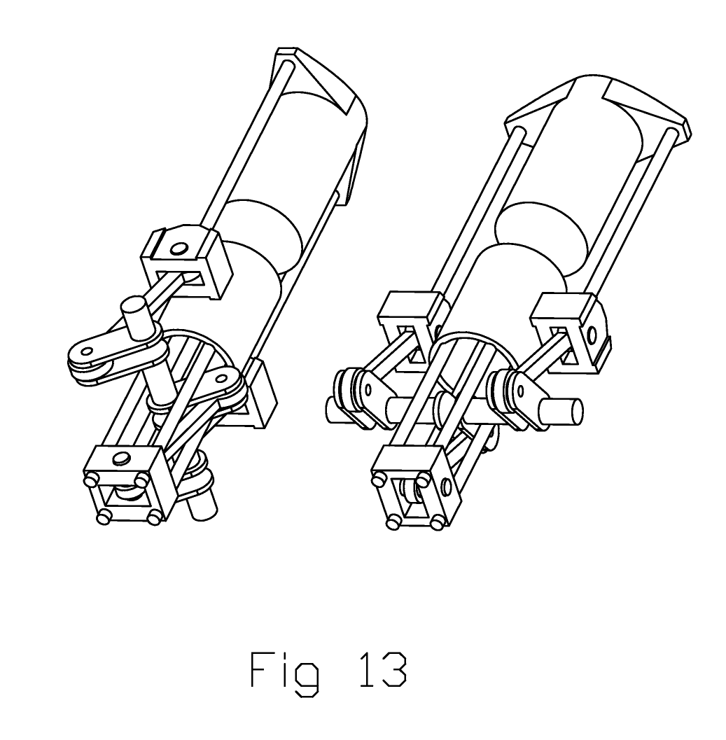

FIG. 13 shows the assembly of the pistons, the connecting rods and the crankshaft of the engine of FIG. 12.

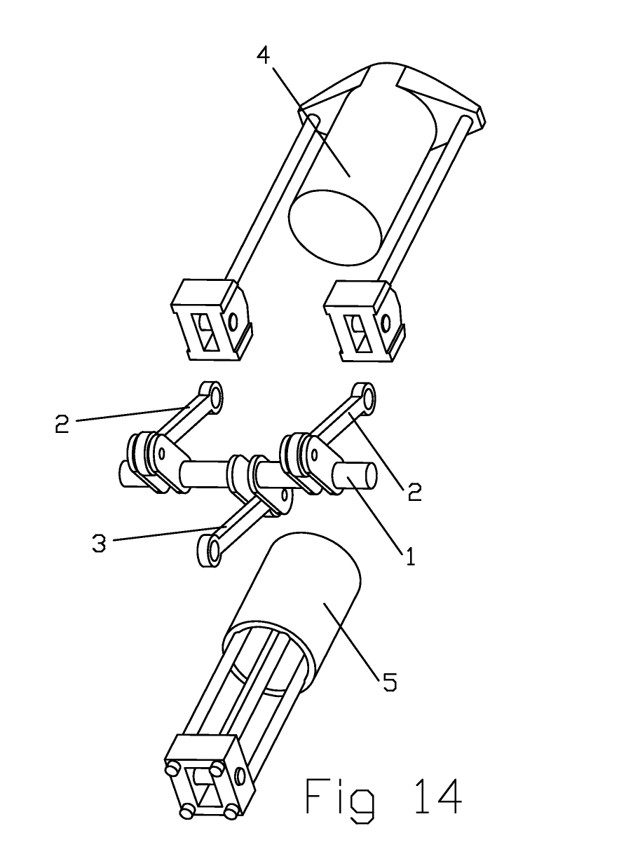

FIG. 14 shows the assembly of FIG. 13 exploded.

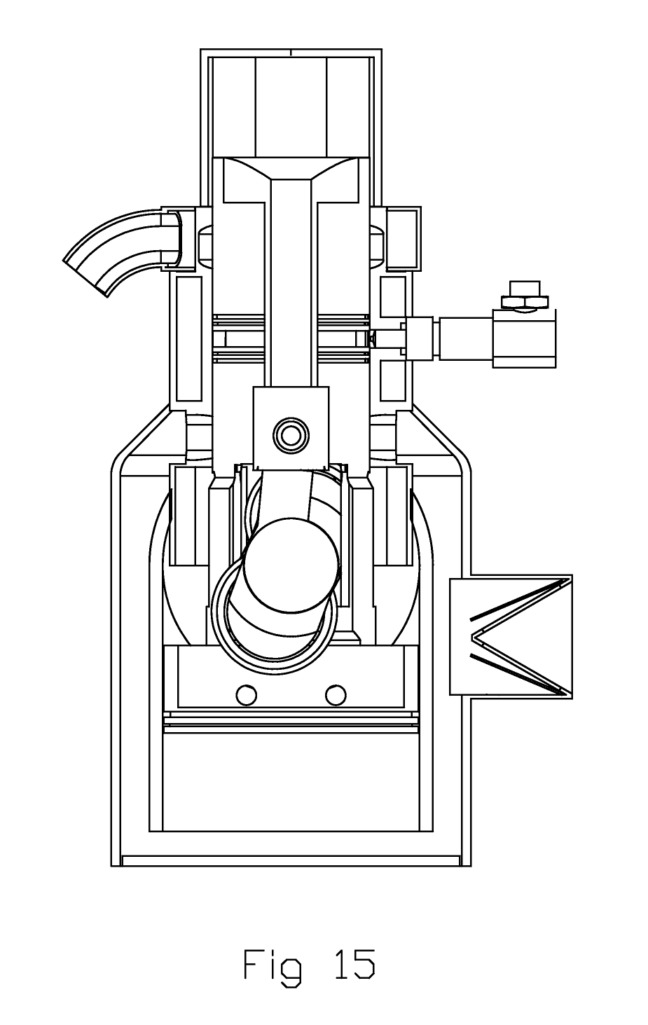

FIG. 15 shows another embodiment of this invention. The covers and the cylinder are sliced. A big diameter “scavenging” piston is secured at the bottom of the lower piston and is slidably fitted into a big diameter cylinder that takes the thrust loads. The upward motion of the scavenging piston creates a vacuum that draws the air through the reed valve, shown at right. The downward motion of the scavenging piston displaces the air, the reed valve traps the air and when the piston uncovers the intake ports the pressurized air enters the combustion cylinder and scavenges the exhaust gas. An injector, shown at middle right, delivers the fuel.

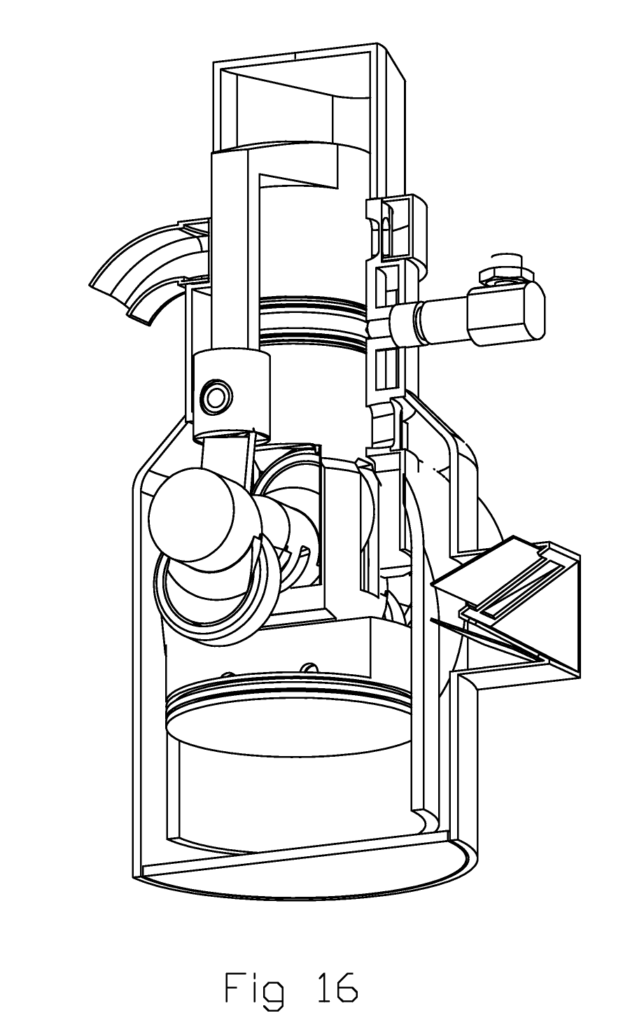

FIG. 16 shows the engine of FIG. 15 from another viewpoint.

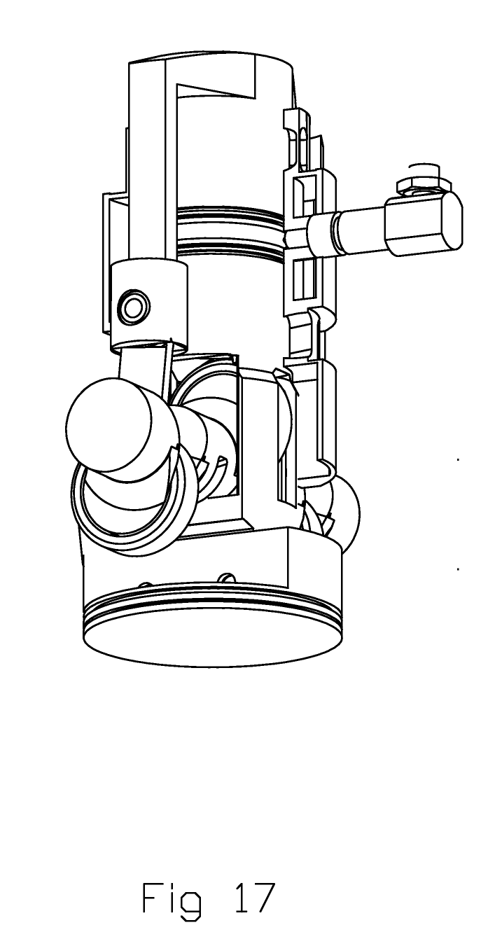

FIG. 17 shows the engine of FIG. 16 after the removal of some parts and covers.

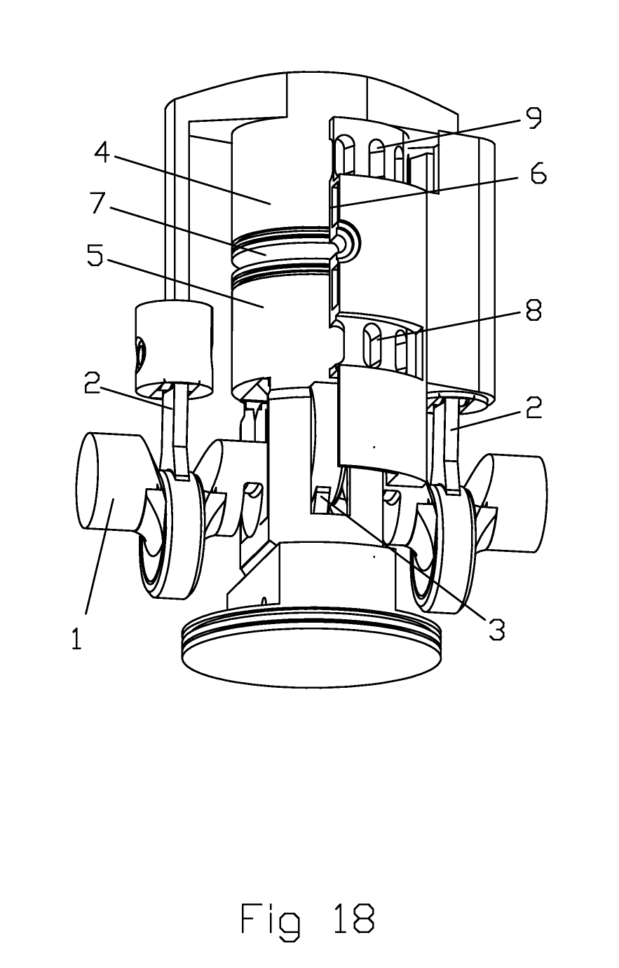

FIG. 18 shows, from another viewpoint, the assembly shown in FIG. 17.

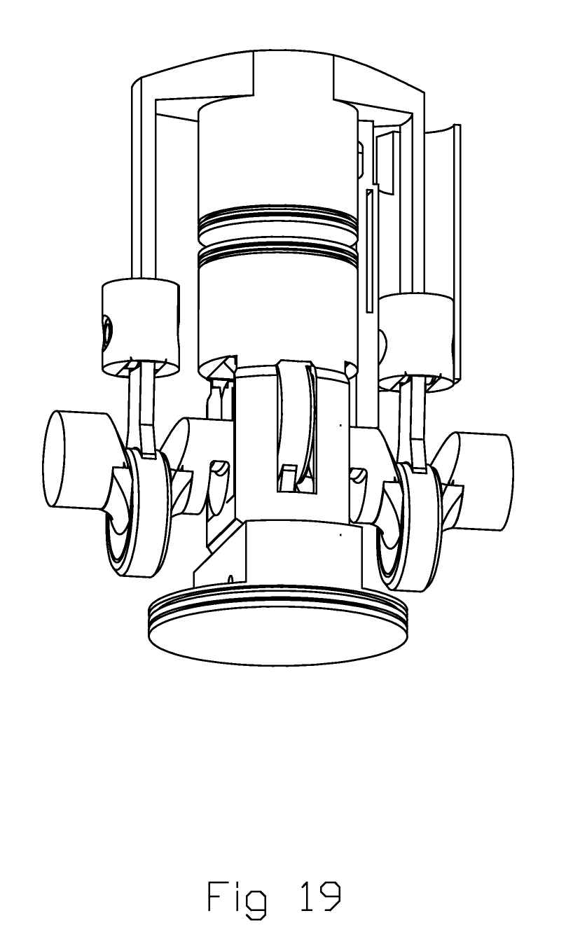

FIG. 19 shows the assembly of FIG. 18 after the removal of a part of the cylinder.

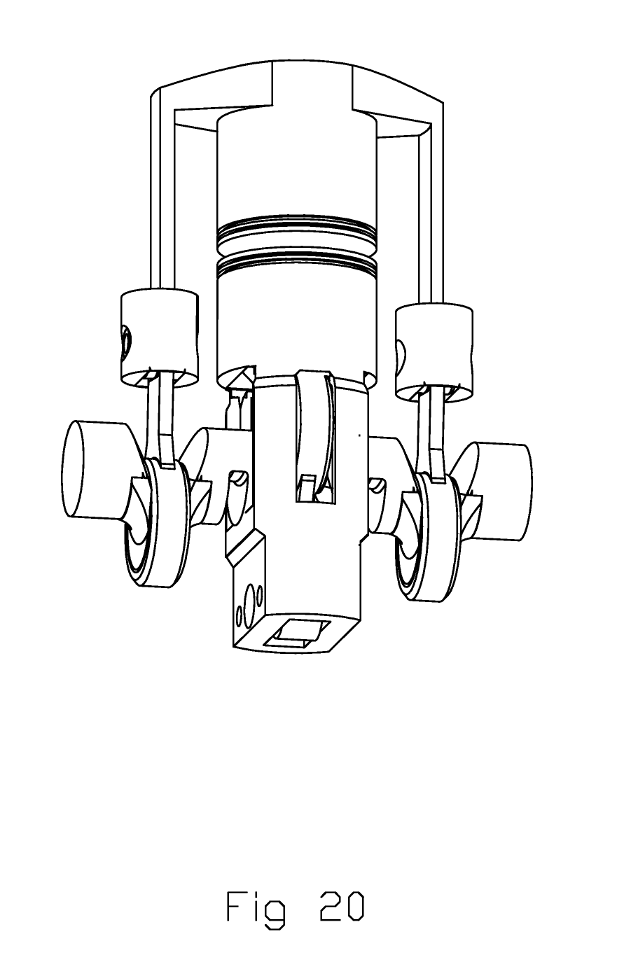

FIG. 20 shows only the pistons, the crankshaft and the connecting rods of the engine of FIG. 15. The upper piston comprises a piston crown and piston rings that seal the upper side of the combustion chamber, a piston skirt that covers and uncovers the exhaust ports, a bridge that transfers the forces from the piston crown to the two side arms, the two side arms with the cylindrical sliders at their lower ends. The lower piston comprises a piston crown and piston rings that seals the lower side of the combustion chamber, a piston skirt that covers and uncovers the intake ports, four pillars around the crankshaft, these pillars transfer the force from the piston crown to the lower end, where the wrist pin is. The high pressure inside the combustion chamber, loads all the three connecting rods exclusively in tension, i.e. both pistons are drivingly coupled to the crankshaft by pullrods.

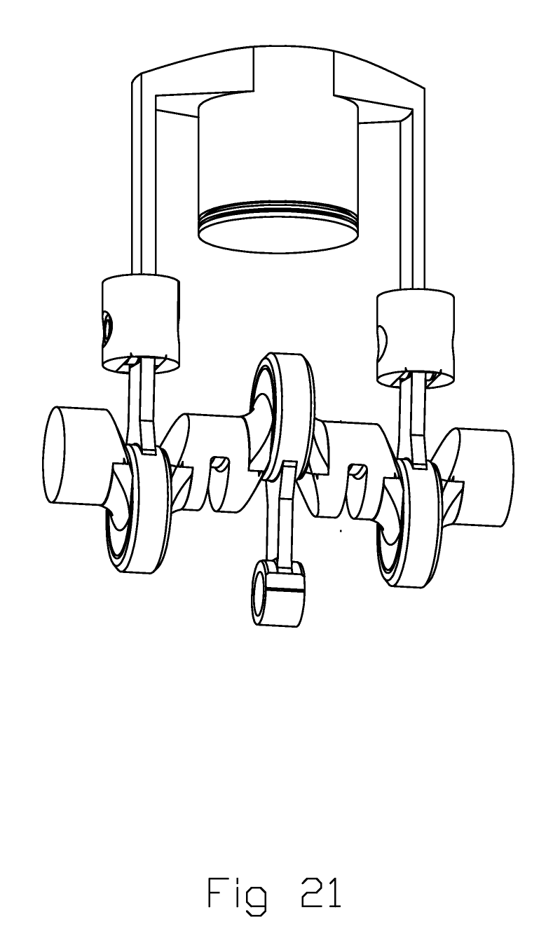

FIG. 21 shows the assembly shown in FIG. 20 after the removal of the lower piston.

In a first preferred embodiment, FIGS. 9 to 14, the crankshaft (1) drives, by means of the pullrods (2) and (3), the two opposed pistons (4) and (5) respectively.

The pullrod arrangement causes a longer piston dwell around the combustion, as compared to the conventional engine, and a shorter piston dwell during the scavenging.

The pistons (4) and (5) are slidably fitted into the same cylinder (6) and seal two sides of the same combustion chamber (7) therein.

The cylinder (6) comprises intake ports (8) and exhaust ports (9) that are covered and uncovered by the reciprocating pistons.

The connecting rod of the upper piston and the connecting rod of the lower piston are, in case of symmetrical timing, always parallel.

With equal diameters of the two opposed pistons, the forces applied to the crankshaft are parallel and equal, i.e. the total force on the main crankshaft bearings is zero. The same is true for the inertia forces: in case of equal mass of the two reciprocating assemblies, the total inertia force on the main bearings of the crankshaft is always zero.

In case of symmetrical timing, i.e. wherein both pistons stop simultaneously, the engine balance can be perfect as regards the inertia forces and the inertia moments. For the complete balance of the inertia forces generated by the reciprocating masses, the stroke of the first piston times the reciprocating mass corresponding to the first piston must be equal to the stroke of the second piston times the reciprocating mass corresponding to the second piston. In some applications the symmetrical timing may be preferable, especially when the scavenging pumps are of the volumetric type.

In case of asymmetrical timing, the substantially faster motion of the pistons over the ports, caused by the pullrod-arrangement, enables a substantially smaller offset, relative to their fully balanced arrangement, of the crankshaft journals, which is advantageous for the dynamic balancing. In the Junkers engine with pushrods, the optimum breathing was achieved by retarding the intake crankshaft for some 11 degrees relative to the exhaust crankshaft. This optimum timing is characterized by the volume V1 of the combustion chamber the moment the exhaust ports open at f1 crank angle, by the volume V2 of the combustion chamber the moment the intake ports open at f2 crank angle, by the volume V3 of the combustion chamber the moment the exhaust ports close at f3 crank angle, and by the volume V4 of the combustion chamber the moment the intake ports close at f4 crank angle. In order to achieve by the pullrod arrangement the same, with reference to the volume of the combustion chamber, scavenging scheme, the exhaust ports must open when the volume of the combustion chamber is V1 at f1′ crank angle, the intake ports must open when the volume of the combustion chamber is V2 at f2′ crank angle, the exhaust ports must close when the volume of the combustion chamber is V3 at f3′ crank angle, and the intake ports must close when the volume of the combustion chamber is V4 at f4′ crank angle, wherein f1′ is bigger than f1, f2′ is bigger than f2, f3′ is smaller than f3, and f4′ is smaller than f4. I.e. the pullrod arrangement needs a smaller offset of the crankpins, from their symmetrical timing arrangement, in order to achieve the same timing asymmetry with the Junkers dual crankshaft engine: about 7 degrees instead of the 11 of the Junkers.

In case the opposite, to the combustion chamber, side of a piston serves as the scavenging pump in the pullrod arrangement, the shorter time provided for the scavenging process is compensated by the longer dwell of the piston of the scavenging pump at its maximum volume position, and by the small “dead volume” of the scavenging pump.

In a second preferred embodiment, FIGS. 15 to 21, the opposite to the combustion chamber side of the lower piston forms a scavenging pump. The diameter of the scavenging piston defines the scavenging ratio. Through proper ducts the fresh air flows to the intake ports awaiting the piston to uncover them.

In a third preferred embodiment, FIG. 8, the bore of the combustion cylinder increases towards the ports to decrease the friction and the wear of the piston rings at the area where the pressure is low, and especially over the port bridges.

In a fourth preferred embodiment, FIG. 6, both pistons are drivingly coupled to the same unique crankshaft by pushrods. In case of symmetrical timing, i.e. 180 degrees offset between the crankpins, the balance of the inertia forces is perfect. But the time for the combustion is as short as in a conventional engine, i.e. some 30% to 40% shorter than the combustion time of the arrangement of FIG. 7, depending on the stroke/rod ratio.

A variation of the proposed arrangements is the case wherein the cylinder comprises two halves.

The two halves may have different bores.

The two halves may be arranged at some wide angle to provide asymmetrical timing, for instance, or to provide a combustion chamber having a more suitable and efficient form.

The crankshaft may have some slight offset from the cylinder axis, as in the conventional engines. This also generates an asymmetrical timing.

1. An internal combustion engine having a basic module comprising:
a single crankshaft having a plurality of journals;
a single cylinder having a first piston and a second piston reciprocably disposed therein and forming a combustion chamber therebetween,
a first connecting rod that drivingly couples the first piston to a corresponding journal on the crankshaft;
a second connecting rod that drivingly couples the second piston to a corresponding journal on the crankshaft,
said first and second connecting rods are either both pullrods or both pushrods.

2. An internal combustion engine according the claim 1 characterized in that the offset of the crankshaft is smaller than a quarter of the cylinder bore.

3. An internal combustion engine according the claim 1 characterized in that at least one piston is drivingly coupled to the crankshaft by a pair of connecting rods disposed outside the cylinder at opposite sides of the cylinder.

4. An internal combustion engine according the claim 1 characterized in that the opposite to the combustion chamber side of at least one piston serves a scavenging pump or compressor or pump.

5. An internal combustion engine according the claim 1 characterized in that the cylinder is tapered being wider towards the ports.

6. An internal combustion engine according the claim 1 characterized in that the crankshaft comprises recessions to allow for a shorter piston and a shorter engine.

7. An internal combustion engine comprising:
a crankshaft;
a combustion chamber;
a first piston sealing one side of said combustion chamber, said first piston is drivingly coupled to the crankshaft by a pullrod;
a second piston sealing an opposite side of said combustion chamber, said second piston is drivingly coupled to the crankshaft by a pullrod.

8. An internal combustion engine according the claim 7 characterized in that at least one piston is drivingly coupled to the crankshaft by a pair of connecting rods disposed at opposite sides of the combustion chamber.

9. An internal combustion engine according the claim 7 characterized in that the engine has more than one combustion chambers and all combustion chambers are served by the same single crankshaft and there is a substantial crankshaft angle difference between the explosions of the different combustion chambers.

10. A modified Junkers-Doxford opposed piston engine characterized in that the closer to the crankshaft piston is drivingly coupled to the crankshaft by a pullrod to balance the second order inertia forces and to provide additional time for the injection and the combustion of the fuel.
